(19) United States
(12) Patent Application Publication
(10) Pub. No.: US 2024/0419505 A1
(43) Pub. Date: Dec. 19, 2024

(54) INTELLIGENT WORKLOAD SCHEDULING

(71) Applicant: International Business Machines Corporation, Armonk, NY (US)

(72) Inventors: Guang Han Sui, Beijing (CN); Mai Zeng, Shi Jing Shan (CN); Min Cheng, Beijing (CN); Peng Hui Jiang, Beijing (CN)

(21) Appl. No.: 18/336,972

(22) Filed: Jun. 17, 2023

(51) Int. Cl. G06F 9/50; G06F 16/23

(52) U.S. Cl. CPC G06F 9/505; G06F 9/5038; G06F 16/2386; G06F 2209/503

(57) ABSTRACT

In an approach for intelligent workload scheduling, a processor groups a plurality of batch jobs based on workload resource requests and dependencies of each batch job resulting in a plurality of groups. A processor schedules the plurality of batch jobs based on the plurality of groups. A processor monitors workload resource usage of system for running the plurality of batch jobs and a plurality of transaction workloads. A processor identifies one or more scheduled transaction workloads will not be able to be completed in under a preset time threshold. A processor reduces a resource quota of one or more batch jobs of the plurality of batch jobs based on type of resource that is needed for the one or more scheduled transaction workloads.

### BACKGROUND OF THE INVENTION

The present invention relates generally to the field of workload scheduling, and more particularly to intelligent workload scheduling.

A transactional workload means that over time, the database is getting requests for data and various changes to that data from different users. The modifications that are made are known as transactions. For example, a transactional workload is built to aid in transactions such as in banking or accounting systems. Relational databases were designed to handle transactional workloads. Relational databases can scale as needed, ensure transactional consistency, and have quick, responsive queries.

Batch processing is a method of scheduling groups of jobs (batches) to be processed at the same time as determined by an Information Technology (IT) professional. Traditionally, batch workloads have been processed during batch windows, which are periods of time when overall central processing unit (CPU) usage is low (typically overnight). The reason for this is two-fold: (1) batch workloads can require high usage of the CPU, occupying resources that are needed for other operational processes during the business day; and (2) batch workloads are typically used to process transactions and to produce reports, for example, gathering all sales records that were created over the course of the business day.

Today, batch processing is done through job schedulers, batch processing systems, workload automation solutions, and applications native to operating systems. The batch processing tool receives the input data, accounts for system requirements, and coordinates scheduling for high-volume processing. Batch processing requires non-continuous data and is not highly time sensitive.

### SUMMARY

Aspects of an embodiment of the present invention disclose a method, computer program product, and computer system for intelligent workload scheduling. A processor groups a plurality of batch jobs based on workload resource requests and dependencies of each batch job resulting in a plurality of groups. A processor schedules the plurality of batch jobs based on the plurality of groups. A processor monitors workload resource usage of system for running the plurality of batch jobs and a plurality of transaction workloads. A processor identifies one or more scheduled transaction workloads will not be able to be completed in under a preset time threshold. A processor reduces a resource quota of one or more batch jobs of the plurality of batch jobs based on type of resource that is needed for the one or more scheduled transaction workloads.

### BRIEF DESCRIPTION OF THE DRAWINGS

FIG. 1 is a functional block diagram illustrating a distributed data processing environment, for running an intelligent workload scheduling program, in accordance with an embodiment of the present invention.

FIG. 2 is a flowchart depicting operational steps of the intelligent workload scheduling program, for intelligent workload scheduling to avoid causing transaction peak time, running on a computer of the distributed data processing environment of FIG. 1, in accordance with an embodiment of the present invention.

FIG. 3 depicts an example grouping of jobs as done by intelligent workload scheduling program, in accordance with an embodiment of the present invention.

### DETAILED DESCRIPTION

Embodiments of the present invention recognize that businesses (e.g., banking businesses) have two types of workloads—online transaction workloads and batch job workloads—that may interfere with each other. Customers of a business always have the potential of trying to complete an online transaction during transaction peak time, which is defined as when the transaction response time or time to complete a transaction exceeds a pre-set threshold, e.g., a core-system transaction response time is more than 3 seconds during peak time, especially when online transaction workloads and batch job workloads are going at the same time. The pre-set threshold, which defines a threshold time to complete a transaction, can be set and modified by the business. This transaction peak time, in which the computing resources available cannot handle the number of workloads running, can be caused by batch job workloads, online transaction workloads, or some combination of both.

One known solution involves reserving certain resources for certain transactions, but it can be difficult to know the quantity of resources needed and may lead to resources not being used. Another known solution involves pausing one batch job workload to release some resources for use for another workload, but this may cause delay in other jobs that depend on the paused batch job workload and some transaction workloads might not be able to be executed if the paused batch job workload holds a lock needed by another transaction. Another known solution involves terminating a batch job to release resources for another job, but whatever part of the workload that was in process or finished is lost and restarting the batch job at a later time may prevent the job from being finished at the original expected complete time. Thus, embodiments of the present invention recognize the need for a way to intelligently schedule workloads running and system resources during a transaction peak time.

Embodiments of the present invention provide a method and system for intelligent workload scheduling with the goal of limiting causing transaction peak time. Embodiments of the present invention provide this by (1) classifying batch jobs by workload resource requests and dependencies, (2) scheduling batch jobs based on the classification with the goals of keeping resources balanced among the jobs and avoiding resource conflicts, (3) monitoring the system of running jobs and flagging transactions that cannot be completed in time, (4) reducing resource quota of running batch jobs for corresponding transactions to help ensure transactions can be finished in time, and (5) when there are not enough resources for potential upcoming transaction, reducing the resource quota of running batch jobs.

Embodiments of the present invention classify batch jobs by workload resource requests and dependencies by putting jobs that use a same database table or have another one or more dependencies into a same group. Embodiments of the present invention schedule batch jobs based on the groupings by scheduling batch jobs from different groups at the same time allowing for competition of resources among running jobs to be low and completion of the jobs in a shorter amount of time. This scheduling provides a smooth-running environment for incoming transactions and causes less transaction peak times by creating less competition for resources among jobs. Embodiments of the present invention monitor the system by monitoring workload resource usage (e.g., database table, CPU, memory, etc.) in the system and identifying any scheduled transactions that will not be able to be finished in an expected time. Embodiments of the present invention reduce resource quota of running batch jobs to help all scheduled transactions finish in an expected time or ensure the time to complete scheduled transactions do not exceed a pre-set threshold.

Embodiments of the present invention provide several advantages: (1) enabling transactions to be completed in a time as expected, (2) improving quality of service of transaction processing. (3) removing the need to reserve resources for jobs, (4) enabling batch jobs to be completed in a shorter time, and (5) running a system with minimal to no peak transaction times.

Implementation of embodiments of the invention may take a variety of forms, and exemplary implementation details are discussed subsequently with reference to the Figures.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

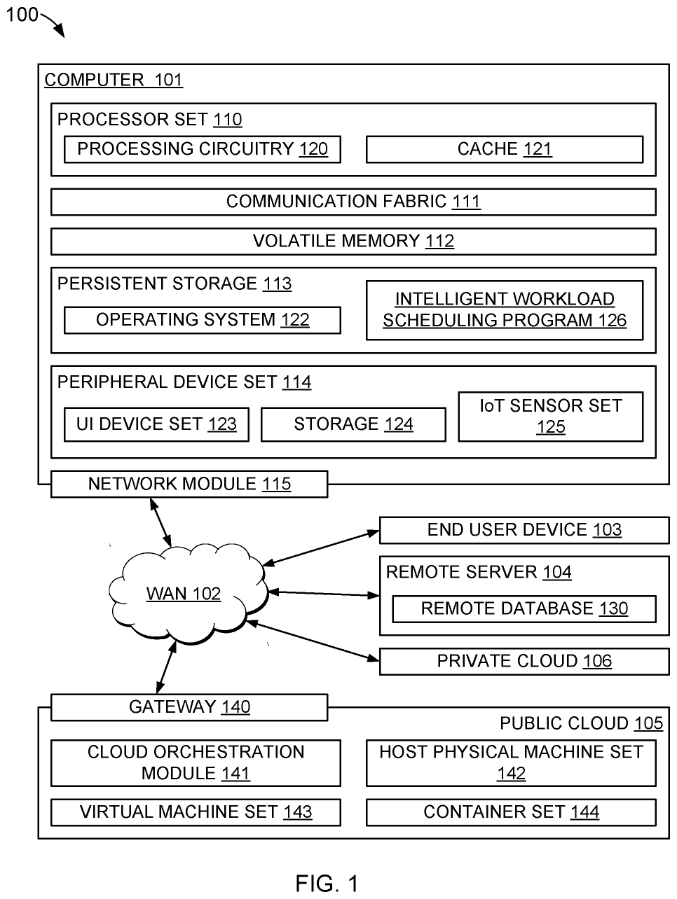

In FIG. 1, computing environment 100 contains an example of an environment for the execution of at least some of the computer code involved in performing the inventive methods, such as intelligent workload scheduling program 126. In addition to block 126, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 126, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processors set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 116 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 116 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

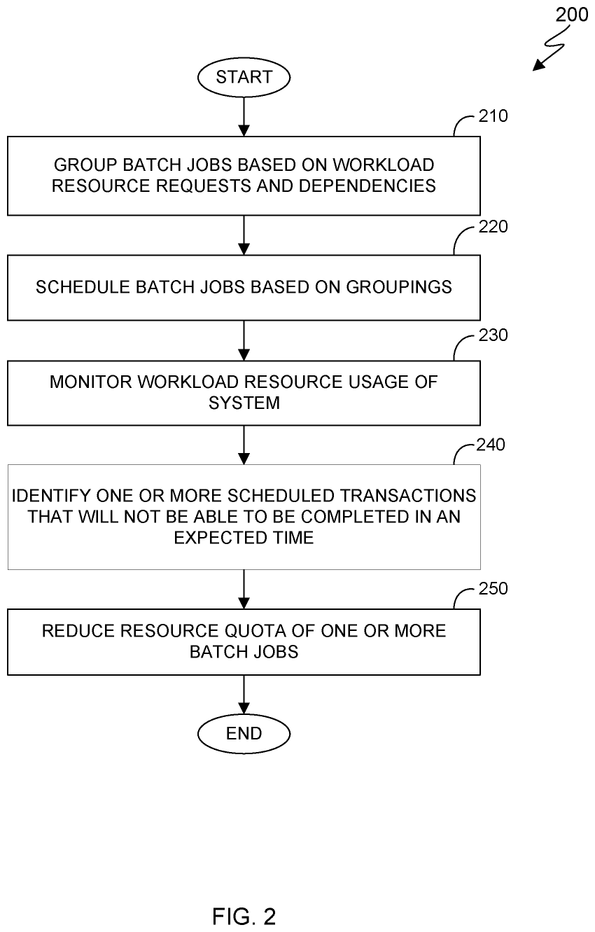

Intelligent workload scheduling program 126 operates intelligently schedule workloads to avoid causing a transaction peak time by grouping batch jobs (that have not been scheduled yet) based on workload resource requests and dependencies, scheduling the batch jobs based on the groupings, monitoring the system of running batch jobs and incoming transaction workloads, and in response to identifying a transactional workload will not be completed in under a threshold time, reducing resource quota of one or more running batch jobs. A process flow of intelligent workload scheduling program 126 is depicted and described in further detail with respect to FIG. 2.

FIG. 2 is a flowchart 200 depicting operational steps of a process flow of intelligent workload scheduling program 126, for intelligent workload scheduling to avoid causing a transaction peak time, running on computer 101 of computing environment 100 of FIG. 1 in accordance with an embodiment of the present invention. In an embodiment, the process flow of intelligent workload scheduling program 126 executes on a computer (e.g., computer 101 of FIG. 1), a processor (e.g., a processor of processor set 110 of FIG. 1), and/or processing circuitry (e.g., processing circuitry of processor set 110), to optimize similarity assessment of a data corpus. It should be appreciated that the process depicted in FIG. 2 illustrates one possible iteration of the process flow of intelligent workload scheduling program 126.

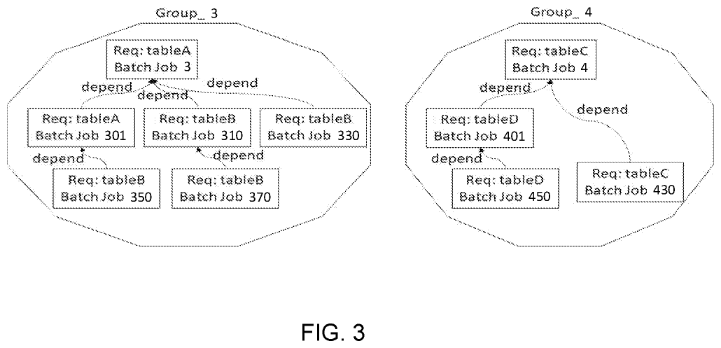

In step 210, intelligent workload scheduling program 126 groups batch jobs based on workload resource requests and dependencies. In an embodiment, intelligent workload scheduling program 126 groups batch jobs based on the resources requested by each batch job and the dependencies of each batch job (i.e., which jobs are dependent on another job). In an embodiment, intelligent workload scheduling program 126 groups batch jobs by putting jobs that use a same database table and/or have similar dependencies into a same group, as shown in FIG. 3. In FIG. 3, two groupings—Group 3 and Group 4—are shown, in which batch jobs requiring tableA or tableB are in Group 3 and batch jobs requiring tableC or tableD are in Group 4. Additionally, jobs that depend on another batch job completing first are grouped together, such as batch job 350 depending on batch job 301 and batch job 301 depending on batch job 3, and thus, batch job 3 and batch job 301 will have to be completed before batch job 350 can be run.

In step 220, intelligent workload scheduling program 126 schedules batch jobs based on the groupings. In an embodiment, intelligent workload scheduling program 126 schedules batch jobs based on the groupings by scheduling batch jobs from different groups at the same time allowing for competition of resources among running jobs to be low and completion of the jobs in a shorter amount of time. This intelligent scheduling provides a smooth-running environment for incoming transaction workloads and causes less transaction peak times by creating less competition for resources among jobs.

In an embodiment, upon an initial setup of a job scheduling system, intelligent workload scheduling program 126 groups all batch jobs that are pending based on workload resource requests and dependencies and then schedules these batch jobs based on the groupings. Then, once this initial setup is complete, as new batch jobs come in, intelligent workload scheduling program 126 identifies a group for a new respective batch job to join or creates a new group with the new batch job and schedules the new batch job based on the grouping.

In step 230, intelligent workload scheduling program 126 monitors workload resource usage (e.g., database table, CPU usage, memory usage, etc.) of the system. In an embodiment, intelligent workload scheduling program 126 continuously monitors a workload resource usage (e.g., database table, CPU usage, memory usage, etc.) of the system (i.e., system running the transaction workloads and batch job workloads). In an embodiment, intelligent workload scheduling program 126 continuously monitors the workload resource usage of the system looking for scheduled transactions (i.e., transaction workloads) that will not be able to be completed in an expected time, i.e., transactions scheduled during a transaction peak time, e.g., a transaction will take longer than a pre-set threshold to complete.

In step 240, intelligent workload scheduling program 126 identifies one or more scheduled transactions that will not be able to be completed in an expected time. In an embodiment, intelligent workload scheduling program 126 identifies one or more scheduled transactions that will not be able to be completed in an expected time or in under a preset time threshold based on a resource usage limit (i.e., a resource usage is at its limit and there is not enough of the resource to run and complete one or more transactional workloads in an expected time) (e.g., CPU limit, memory limit, etc.).

In step 250, intelligent workload scheduling program 126 reduces a resource quota of one or more batch jobs. In an embodiment, intelligent workload scheduling program 126 reduces a resource quota of one or more (currently running) batch jobs to ensure that the one or more identified schedule transactions can be completed in an expected time or ensure the time to complete the one or more identified scheduled transactions does not exceed a pre-set time threshold.

If a transaction cannot be completed in the expected time due to a CPU limit, intelligent workload scheduling program 126 reduces a CPU quota of one or more running batch jobs from a group that uses different tables than the transaction and then provides the reduced CPU quota to the transaction. In an embodiment, intelligent workload scheduling program 126 selects the one or more running batch jobs that will have their CPU quota reduced based on one or more policies, such as selecting one running batch job with a biggest CPU usage, selecting a set of running batch jobs with top CPU usage, and selecting running batch jobs at random.

If a transaction cannot be completed in the expected time due to a memory limit, intelligent workload scheduling program 126 selects running batch jobs from different groups and then from those selected batch jobs chooses at least one batch job whose history peak memory usage is lower than the memory quota for the respective batch job. In an embodiment, intelligent workload scheduling program 126 reduces the memory quota of the at least one running batch job to a respective history peak memory usage leaving a reserve amount of memory (i.e., reserved memory). In an embodiment, intelligent workload scheduling program 126 releases this reserved memory (which is the difference between the initial memory quota and the history peak memory usage for each batch job), cleans memory caches, and then provides the released memory quota to the transaction.

If there are not enough resources for potential upcoming transactions based on historical information, intelligent workload scheduling program 126 reduces the resource quota of one or more running batch jobs before a potential resource shortage occurs and maintains a resource buffer for the potential upcoming transactions.

What is claimed is:

1. A method comprising:
grouping, by one or more processors, a plurality of batch jobs based on workload resource requests and dependencies of each batch job resulting in a plurality of groups;
scheduling, by the one or more processors, the plurality of batch jobs based on the plurality of groups;
monitoring, by the one or more processors, workload resource usage of system for running the plurality of batch jobs and a plurality of transaction workloads;
identifying, by the one or more processors, one or more scheduled transaction workloads will not be able to be completed in under a preset time threshold; and
reducing, by the one or more processors, a resource quota of one or more batch jobs of the plurality of batch jobs based on type of resource that is needed for the one or more scheduled transaction workloads.

2. The method of claim 1, wherein scheduling the plurality of batch jobs based on the grouping further comprises:
scheduling, by the one or more processors, batch jobs of the plurality of batch jobs from different groups of the plurality of groups at a same time which lowers competition between resources.

3. The method of claim 1, wherein the workload resource usage includes database table usage, CPU usage, and memory usage.

4. The method of claim 1, wherein identifying the one or more scheduled transaction workloads that will not be able to be completed in under the preset time threshold is based on a workload resource usage limit.

5. The method of claim 1, further comprising:
wherein the type of resource that is needed for the one or more scheduled transaction workloads is CPU;
reducing, by the one or more processors, a CPU quota of one or more running batch jobs from a group that uses different tables than the one or more scheduled transaction workloads; and
providing, by the one or more processors, the reduced CPU quota to the one or more scheduled transaction workloads.

6. The method of claim 5, further comprising:
selecting, by the one or more processors, the one or more running batch jobs based on one or more policies, wherein the one or more policies comprise at least one of selecting one running batch job with a biggest CPU usage, selecting a set of running batch jobs with top CPU usage, and selecting running batch jobs at random.

7. The method of claim 1, further comprising:
wherein the type of resource that is needed for the one or more scheduled transaction workloads is memory;
selecting, by the one or more processors, one or more running batch jobs from different groups of the plurality of groups;
choosing, by the one or more processors, from the selected one or more running batch jobs, at least one batch job whose history peak memory usage is lower than a memory quota for the at least one batch job;
reducing, by the one or more processors, the memory quota of the at least one batch job to the history peak memory usage leaving a reserve amount of memory;
releasing, by the one or more processors, the reserve amount of memory; and
providing, by the one or more processors, the released reserve amount of memory to the one or more scheduled transaction workloads.

8. A computer program product comprising:
one or more computer readable storage media and program instructions collectively stored on the one or more computer readable storage media, the stored program instructions comprising:
program instructions to group a plurality of batch jobs based on workload resource requests and dependencies of each batch job resulting in a plurality of groups;
program instructions to schedule the plurality of batch jobs based on the plurality of groups;
program instructions to monitor workload resource usage of system for running the plurality of batch jobs and a plurality of transaction workloads;
program instructions to identify one or more scheduled transaction workloads will not be able to be completed in under a preset time threshold; and
program instructions to reduce a resource quota of one or more batch jobs of the plurality of batch jobs based on type of resource that is needed for the one or more scheduled transaction workloads.

9. The computer program product of claim 8, wherein the program instructions to schedule the plurality of batch jobs based on the grouping further comprise:
program instructions to schedule batch jobs of the plurality of batch jobs from different groups of the plurality of groups at a same time which lowers competition between resources.

10. The computer program product of claim 8, wherein the workload resource usage includes database table usage, CPU usage, and memory usage.

11. The computer program product of claim 8, wherein the program instructions to identify the one or more scheduled transaction workloads that will not be able to be completed in under the preset time threshold is based on a workload resource usage limit.

12. The computer program product of claim 8, further comprising:
wherein the type of resource that is needed for the one or more scheduled transaction workloads is CPU;
program instructions to reduce a CPU quota of one or more running batch jobs from a group that uses different tables than the one or more scheduled transaction workloads; and
program instructions to provide the reduced CPU quota to the one or more scheduled transaction workloads.

13. The computer program product of claim 12, further comprising:
program instructions to select the one or more running batch jobs based on one or more policies, wherein the one or more policies comprise at least one of selecting one running batch job with a biggest CPU usage, selecting a set of running batch jobs with top CPU usage, and selecting running batch jobs at random.

14. The computer program product of claim 8, further comprising:
wherein the type of resource that is needed for the one or more scheduled transaction workloads is memory;
program instructions to select one or more running batch jobs from different groups of the plurality of groups;
program instructions to choose, from the selected one or more running batch jobs, at least one batch job whose history peak memory usage is lower than a memory quota for the at least one batch job;
program instructions to reduce the memory quota of the at least one batch job to the history peak memory usage leaving a reserve amount of memory;
program instructions to release the reserve amount of memory; and
program instructions to provide the released reserve amount of memory to the one or more scheduled transaction workloads.

15. A computer system comprising:
one or more computer processors;
one or more computer readable storage media;
program instructions collectively stored on the one or more computer readable storage media for execution by at least one of the one or more computer processors, the stored program instructions comprising:
program instructions to group a plurality of batch jobs based on workload resource requests and dependencies of each batch job resulting in a plurality of groups;
program instructions to schedule the plurality of batch jobs based on the plurality of groups;
program instructions to monitor workload resource usage of system for running the plurality of batch jobs and a plurality of transaction workloads;
program instructions to identify one or more scheduled transaction workloads will not be able to be completed in under a preset time threshold; and
program instructions to reduce a resource quota of one or more batch jobs of the plurality of batch jobs based on type of resource that is needed for the one or more scheduled transaction workloads.

16. The computer system of claim 15, wherein the program instructions to schedule the plurality of batch jobs based on the grouping further comprise:
program instructions to schedule batch jobs of the plurality of batch jobs from different groups of the plurality of groups at a same time which lowers competition between resources.

17. The computer system of claim 15, wherein the program instructions to identify the one or more scheduled transaction workloads that will not be able to be completed in under the preset time threshold is based on a workload resource usage limit.

18. The computer system of claim 15, further comprising:
wherein the type of resource that is needed for the one or more scheduled transaction workloads is CPU;
program instructions to reduce a CPU quota of one or more running batch jobs from a group that uses different tables than the one or more scheduled transaction workloads; and
program instructions to provide the reduced CPU quota to the one or more scheduled transaction workloads.

19. The computer system of claim 18, further comprising:
program instructions to select the one or more running batch jobs based on one or more policies, wherein the one or more policies comprise at least one of selecting one running batch job with a biggest CPU usage, selecting a set of running batch jobs with top CPU usage, and selecting running batch jobs at random.

20. The computer system of claim 15, further comprising:
wherein the type of resource that is needed for the one or more scheduled transaction workloads is memory;
program instructions to select one or more running batch jobs from different groups of the plurality of groups;
program instructions to choose, from the selected one or more running batch jobs, at least one batch job whose history peak memory usage is lower than a memory quota for the at least one batch job;
program instructions to reduce the memory quota of the at least one batch job to the history peak memory usage leaving a reserve amount of memory;
program instructions to release the reserve amount of memory; and
program instructions to provide the released reserve amount of memory to the one or more scheduled transaction workloads.
